(19) United States
(12) Patent Application Publication
(10) Pub. No.: US 2009/0208723 A1
(43) Pub. Date: Aug. 20, 2009

(54) INSERT ELEMENT FOR A HOLLOW BODY AND METHOD FOR FITTING THE INSERT ELEMENT INTO THE HOLLOW BODY

(76) Inventor: Ulrich Lindner, Sindelfingen (DE)

Correspondence Address: PATENT CENTRAL LLC;Stephan A. Pendorf, 1401 Hollywood Boulevard, Hollywood, FL, 33020, US

(21) Appl. No.: 12/307,960

(22) PCT Filed: Jul. 13, 2007
(86) PCT No.: PCT/DE07/01259

§ 371 Date: Jan. 8, 2009

(30) Foreign Application Priority Data
Jul. 13, 2006 (DE) 10 2006 032 480.3

(51) Int. Cl. B32B 3/26; B29C 67/20

(52) U.S. Cl. 428/304.4; 264/413

(57) ABSTRACT

An insert element comprising a carrier and an expandable material carried on the carrier, and a method for fitting said insert element into a conductive hollow body, the method comprising the following steps: the insert element is introduced into the hollow body; the insert element is positioned in the hollow body, the contact surface of the insert element coming into contact with the inner wall of the hollow body; a biasing current is applied between the insert element and the hollow body; the insert element and the hollow body are separated, forming an electric arc between the contact surface and the inner wall of the hollow body; a welding current is activated in order to form at least one melted mass on at least one side of the electric arc; the insert element and the hollow body are put together; and the insert element and the hollow body are connected by means of the melted mass located at least on one side.

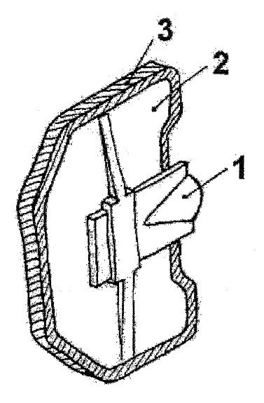

The invention concerns an insert element for a hollow body and a process for introducing the insert element into the hollow body according to the pre-characterizing portion of patent claims 1 and 6. This type of insert element and hollow body is already known from DE 19858903 A1 and DE 10121377 A1.

For safety reasons automobile body work should exhibit a sufficient stiffness and for economical reasons should be as light as possible. In order to achieve both requirements, the foaming of body hollow spaces has already been proposed; see for example DE 19858903 A1 and DE 10121377 A1. For this, a carrier is provided with a formable material, introduced into the hollow space and fixed. Thereafter, the body is painted and heated for drying of the paint. This condition brings about likewise a foaming and hardening of the foamable material. Thereby an internal connection between the hollow body, the foam and the carrier results, whereby the desired stiffening of the hollow body is achieved.

A further field of application of foaming in body hollow spaces is sound attenuation, wherein the foam effectively reduces the sound propagation in the hollow space.

In both fields of application, the introduction of the foamable material is usually laborious and thus expensive, since a simple fixing in place (as described above) is frequently or not at all sufficiently reliable. Thus, the insert elements (or even the foamable material itself) must first be fixed with clips or by other securing means, for example, point spot welding, before the forming can occur. This is associated with substantial investment, in particular in manual labor. This type of securing step should thus be simplified by means of a specially designed insert element and a corresponding process for the introduction thereof into the hollow space.

With respect to the insert element to be produced and the process to be provided, the invention is set forth by the characterizing portion of patent claims 1 and 6. The further claims contain advantages in embodiments and further developments of the inventive insert element and the inventive process.

The task to produce an insert element for a hollow body, in particular a hollow body of a motor vehicle body, which includes a carrier as well as a therewith associated foamable material, is inventively solved thereby, that the carrier includes at least one conductive contact surface shaped or designed for an intended contact with a hollow body, which is shaped or designed in such a manner, that during use the insert element can be conductively contacted with and separated from a source of current while in the hollow body.

The task with regard of the process to be provided for the insertion of the insert element into a conductive hollow body, in particular a hollow body of a motor vehicle, which includes a carrier as well as a therewith associated foamable material, is inventively solved by at least the following steps:
introducing the insert element into the hollow body;
positioning the insert element in the hollow body, whereupon contact between the contact surface of the insert element and the inner wall of the hollow body is produced;
applying a pre-current or bias current between insert element and hollow body;
separating the insert element and the hollow body with formation of an arc between contact surface and inner wall of the hollow body;
switching on an electric arc for forming a melt on at least one side of the arc;
bringing together insert element and hollow body;
joining insert element and hollow body via the at least one melt.

This type of inventive process enables, in conjunction with the inventive insert element, an automated introduction of the foamable material into the vehicle body hollow space, for example by means of robot-guided grippers. Thereby the otherwise necessary manually intensive and the stability compromising boring of securing holes for clips, or the likewise complex and, due to space, only limitedly possible spot welding, can be dispensed with.

It is particularly preferred when the process is designed in such a manner that a magnetic field is produced during welding transverse to the arc and transverse to the orientation of the contact surface, which guides the arc along the contact surface due to the Lorentz-force exerted by it.

Without this magnetic field a comparatively broader arc is necessary for a sufficient welding joint, the formation of which necessitating high current in the order of magnitude of 2000 amp. With the magnetic field, a substantially smaller arc can be guided along the contact surface, whereby a substantially lower current strength of a few 100 As are required. Therewith the magnetic field allows a substantial savings in energy.

An advantageous embodiment of the insert element is given when the contour of the contact surface is designed in such a manner on at least one side that it approaches the contour of the hollow body at an obtuse angle.

This facilitates the ignition of the arc.

A further advantage of the embodiment of the insert element is provided when the carrier is comprised at least substantially of plastic.

This contributes in particular to the weight saving construction requirement. The now as before available and accessible conductive contact surface, preferably metallic contact surface, makes possible the advantageous employment of the process for connection of the inventive insert element with the hollow body.

In order to satisfy the acoustic requirements, it is advantageous when the foamable mass has a sound-attenuating property in the foamed condition. Suitable materials based on PU or epoxy with chemical or physical initiators for forming are commercially available.

In the following the inventive process and the inventive insert element are described in greater detail on the basis of an illustrative embodiment and the FIGURE:

The inventive insert element includes a plastic plate 2 as carrier, of which the cross-section corresponds in reduced scale to the internal cross-section of the body internal space to be foamed. A foamable material 3 based on epoxy is provided along the edge. On one side of the plastic plate 2 a metallic insert 1 is provided, which exhibits an oblong conductive contact surface facing towards the inner wall of the conductive body hollow space. The metallic insert 1 projects on one side beyond the cross-section of the plastic plate 2, so that a contact with the inner wall is possible.

This insert element is gripped by a robot-guided gripper in a plant for building bodies in such a manner that a flow of current from the gripper to the metallic insert 1 can occur. Then, the insert element is introduced via the grippers into the body hollow space and positioned at the desired position. Finally a flow of current is applied via the gripper between the insert element and the hollow body and then the insert element and the hollow body are separated from each other with the simultaneous formation of an arc between contact surface and inner wall of the hollow body. Then, the welding current is switched on, whereby the contact surface of the metallic insert 1 and the inner wall of the hollow body are melted or at least partially melted. Thereafter the insert element and the hollow body are again brought together by means of the gripper, whereby both melts are joined and hardened in the joined condition.

After introduction of all necessary insert elements into all hollow spaces of the body this is dip-coated and thereafter heated for drying. At the same time the foamable materials foam and are hardened.

The inventive process and the inventive insert element have demonstrated themselves in the illustrative embodiment of the above described example as particularly suited for employment in the automobile industry, in particular for sound attenuation and for stiffening of hollow bodies.

In particular, thereby substantial advantages with respect to the expenditure of human labor can be achieved. Further, the stability of the body can be improved in comparison to the securing of the insert element using clips.

1. An insert element for a hollow body, including a carrier (2) as well as a therewith associated foamable material (3), wherein the carrier (2) includes at least one contact surface which is conductive in the area of an intended joining with the hollow body, which insert element is designed in such a manner, that during use of the insert element in the hollow body it is conductively connectable with and separable from a source of current.

2. An insert element according to claim 1, wherein the contour of the contact surface is designed at least on one side in such a manner that it approaches the contour of the hollow body at an obtuse angle.

3. An insert element according to claim 1, wherein the carrier (2) is comprised substantially of plastic.

4. An insert element according to claim 3, wherein the carrier (2) includes a metallic insert (1), which forms the contact surface.

5. An insert element according to claim 1, wherein the foamable material (3) is sound attenuating in the foamed condition.

6. A process for fixing an insert element in a conductive hollow body, wherein said insert element includes a carrier (2) carrying a foamable material (3), wherein the carrier (2) includes at element includes a carrier (2) carrying a foamable material (3), wherein the carrier (2) includes at least one contact surface which is conductive in the area of an intended joining with the hollow body, which insert element is designed in such a manner with respect to the hollow body, that during use of the insert element in the hollow body it is conductively connectable with and separable from a source of current, said process including the following steps:
introducing the insert element into the hollow body;
positioning the insert element into the hollow body, wherein contact is produced between the contact surface of the insert element and the inner wall of the hollow body;
applying a bias current between insert element and hollow body,
separating insert element and hollow body with formation of an arc between contact surface and inner wall of the hollow body;
switching on a welding current for forming at least one melt on at least one side of the arc;
bringing together insert element and hollow body; and
joining insert element and hollow body via the at least one melt.

7. A process according to claim 6, wherein during the welding a magnetic field is produced transverse to the arc, which guides the arc along the contact surface.

8. A process according to claim 6, wherein said carrier has comprises a plate having the same shape, but with reduced size, as the cross section of the hollow body.

9. An insert element as in claim 1, wherein said insert element is adapted to be introduced into a hollow cavity of an automobile bodywork.
